(19) United States
(12) Patent Application Publication
(10) Pub. No.: US 2007/0017747 A1
(43) Pub. Date: Jan. 25, 2007

(54) Lifting station in a surface treatment installation

(76) Inventors: Joerg Robbin, Ammerbuch (DE); Juergen Hanf, Tuebingen (DE)

Correspondence Address: FACTOR & LAKE, LTD, 1327 W. WASHINGTON BLVD., SUITE 5G/H, CHICAGO, IL, 60607, US

(21) Appl. No.: 11/189,088

(22) Filed: Jul. 25, 2005

(51) Int. Cl. B66F 7/00

(52) U.S. Cl. 187/203

(57) ABSTRACT

A lifting station for vertically moving an object, in particular a vehicle body, in a surface treatment installation includes a fixed support structure and a vertically movable lifting cradle which is supported on the support structure and on which at least one conveying device is arranged. According to the invention an energy transfer device, with which energy can be transferred to the conveying device only in at least one selected lifting position of the lifting cradle is provided. As a result, a trailing cable can be dispensed with.

The invention relates to a lifting station for vertically moving an object, in particular a vehicle body, in a surface treatment installation, comprising a fixed support structure and a vertically movable lifting cradle which is supported on the support structure and on which at least one conveying device is arranged.

Surface treatment installations are used for treating surfaces of objects in various ways, e.g. by applying paints and other coatings. Such installations frequently include a plurality of individual treatment stations for different treatment steps, e.g. preparation, painting and drying. For this purpose the objects to be treated, which may be, for example, motor vehicle bodies or other sheet metal parts, are conveyed from treatment station to treatment station by means of a conveyor system.

In this case the surface treatment installation also includes zones between and after the treatment stations, in which the objects to be treated are only conveyed, temporarily stored or sorted. The conveying, temporary storage and sorting of the objects to be treated often takes place on a plurality of levels one above another. In these cases it is necessary to move the objects vertically between different levels.

A vertical movement is also required if individual stations of the surface treatment installation are for certain reasons arranged at different levels relative to other stations. For example, if the objects are to be treated at one station with gases which are heavier than the ambient atmosphere, such a treatment is frequently carried out in a sunken zone, for example, a kind of vat, so that the smallest possible amount of gases escapes via entry and exit openings of the zone. In treatment with lighter gases or with hot air, by contrast, it is more advantageous, for the same reasons, to arrange the treatment zone higher.

Lifting stations known in the prior art, that are provided for vertically moving objects in surface treatment installations, have a lifting cradle which is guided by means of guide rollers in the vertical direction (lifting direction). This means that the lifting cradle can move only in the vertical direction but is fixed with respect to a support structure in the directions perpendicular thereto. Arranged on the lifting cradle is a conveying device which may be, for example, a roller conveyor or a chain conveyor. The conveying device makes it possible to transfer the objects from a conveyor system arranged upstream to the lifting cradle and from there—after the vertical movement—to a conveyor system arranged downstream. The conveyor systems may, of course, also be replaced by other feed devices such as fork-lift trucks or the like.

For its operation during these transfer processes the conveying device requires energy. For this reason, in the known lifting stations the lifting cradle is connected to an external voltage supply via a trailing cable.

It has been shown, however, that such trailing cables are disadvantageous in practice for various reasons. To prevent the trailing cable from touching the usually more or less unprotected surfaces of the objects during displacement of the lifting cradle, or being crushed between moving parts of the lifting station, a guide structure with a plurality of moving parts, which restricts movements of the trailing cable to a predefined spatial area, is generally required. In particular in the case of lifting stations which can attain considerable heights, such guidance structures can be very complex and costly. In addition, trailing cables which tolerate high bending loads over relatively long periods are very expensive. If the lifting station with the lifting cradle is located in a hot zone, e.g. upstream or downstream of a drier, the trailing cables are heavily stressed not only by the movement but also by the ambient air which can be heated above 200° C. In addition, dirt particles can be deposited on the trailing cables and their guide structures and may fall on to freshly painted parts during the movement.

It is therefore the object of the invention so to improve a lifting station of the type mentioned in the introduction that problems associated with the use of trailing cables are at least partially avoided.

This object is achieved in a lifting station of the type mentioned in the introduction by an energy transfer device with which energy can be transferred to the conveying device only in at least one selected lifting position of the lifting cradle.

The invention is based on recognition of the fact that in general the conveying device is in any case actuated only in certain lifting positions of the lifting cradle, which generally include its lower and upper dead centre positions. It is therefore sufficient to make energy available to the conveying device by means of an energy transfer device only when the energy is actually needed. A trailing cable which makes possible an energy supply in all lifting positions is then no longer required.

The energy which is transferred to the conveying device by means of the energy transfer device may in principle be any form of energy which can be converted into the kinetic energy required by the conveying device. Electrical energy, mechanical energy or radiation energy, for example, can be considered.

Electrical energy is advantageous in that relatively large quantities of energy can be transferred to the conveying device at selected lifting positions with low-cost components. For example, the energy transfer device may include a fixed electrical contact and an electrical counter-contact which is arranged on the lifting cradle and cooperates with the fixed contact in the at least one selected lifting position.

If easily inflammable gases or solids are in the environment of the lifting station, it may in some cases be more advantageous to use an energy transfer device which makes possible an inductive transfer of electrical energy. With inductive energy transfer, sparks of the kind which frequently occur with electrical contacts, e.g. with loose contacts, practically cannot be produced. An energy transfer device based on the induction principle may include a first, fixed induction loop and a second induction loop arranged on the lifting cradle.

If energy is to be available at the lifting cradle even when it is not in the at least one selected lifting position, it may be advantageous to provide an energy accumulator arranged on the lifting cradle, with which accumulator energy transferred via the energy transfer device can be temporarily stored and supplied, for example, to the conveying device. With such an energy accumulator the conveying device can be actuated even in lifting positions in which no energy transfer is possible. This energy may be used, for example, for control or measurement systems.

The energy accumulator may be, for example, a pressure accumulator or a flywheel, if the energy is transmitted by mechanical means. In the case of the transfer of electrical energy, the energy accumulator may be a storage battery.

An example of the transmission of mechanical energy by means of the energy transfer device is the supply of a pressurised gas which drives the conveying device pneumatically via a docking station.

However, with the transmission of mechanical energy it is simplest if the lifting station includes a fixed drive unit and a coupling with which kinetic energy can be transmitted from the drive unit to the conveying device. The coupling may be, for example, a friction, toothed or magnetic clutch. The fixed drive unit may also be formed by a conveyor system located before or after the lifting station.

Further advantages and features of the invention will be apparent from the following description of embodiments, with reference to the drawings, in which:

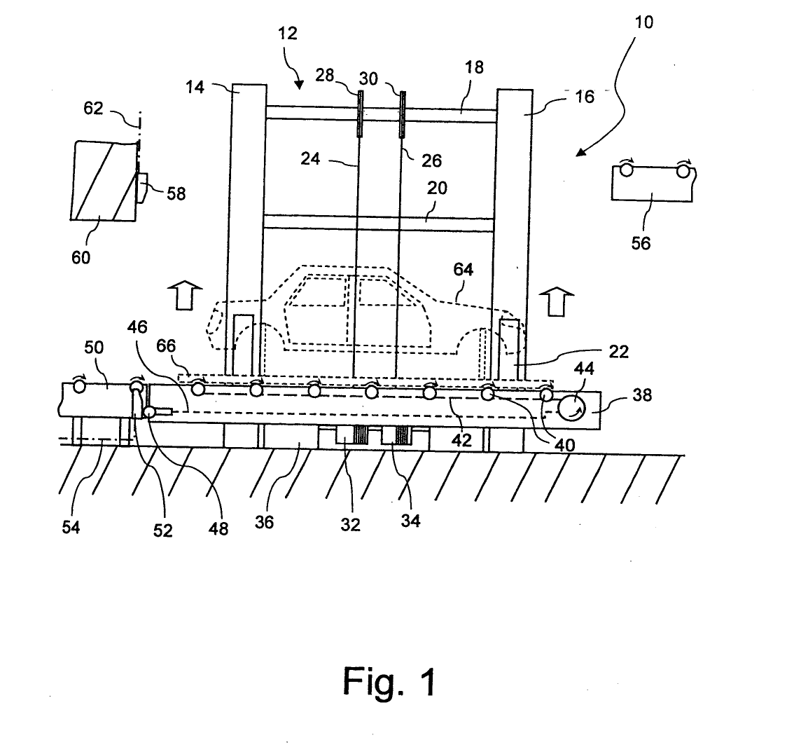

FIG. 1 is a front view of a first embodiment of a lifting station according to the invention, in which energy is transferred by means of sliding electrical contacts, a lifting cradle being located in a lower lifting position;

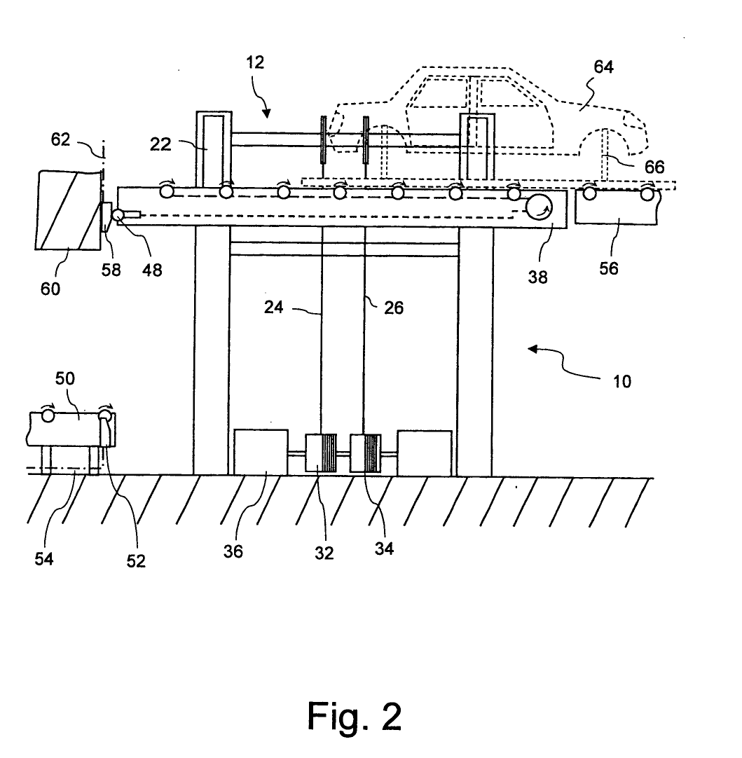

FIG. 2 shows the lifting station illustrated in FIG. 1, the lifting cradle being located in an upper lifting position;

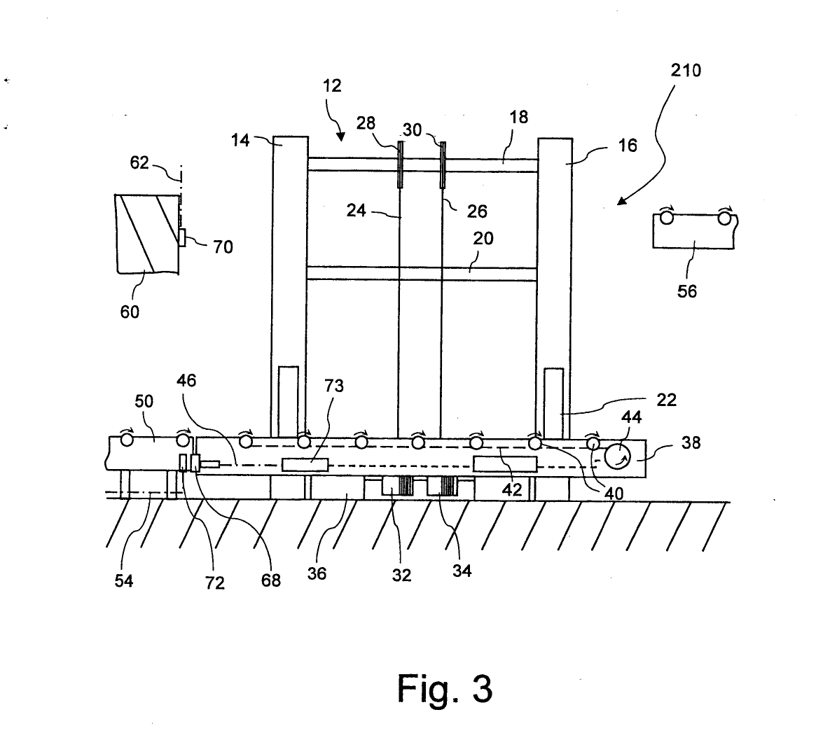

FIG. 3 is a front view of a second embodiment of a lifting station according to the invention, in which energy is transferred inductively, a lifting cradle being located in a lower lifting position;

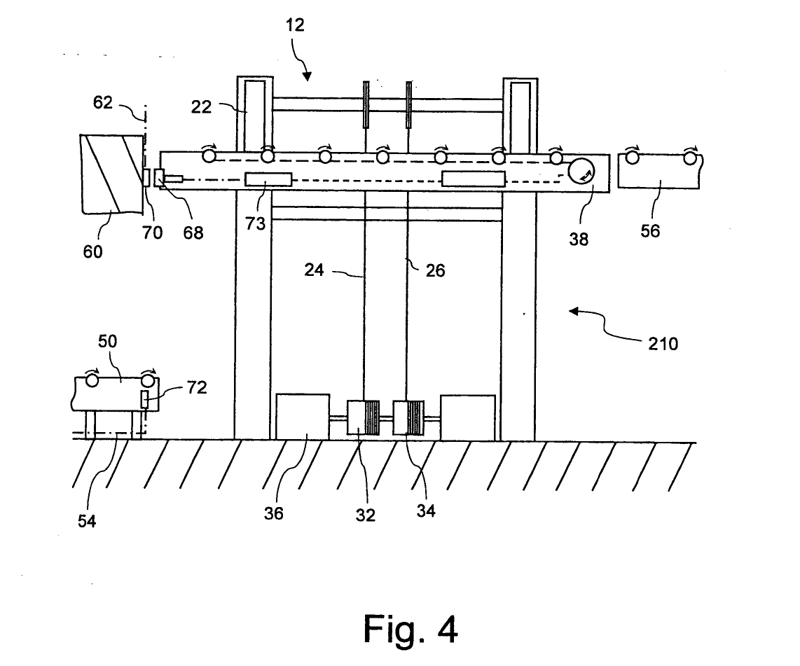

FIG. 4 shows the lifting station illustrated in FIG. 3, the lifting cradle being located in an upper lifting position;

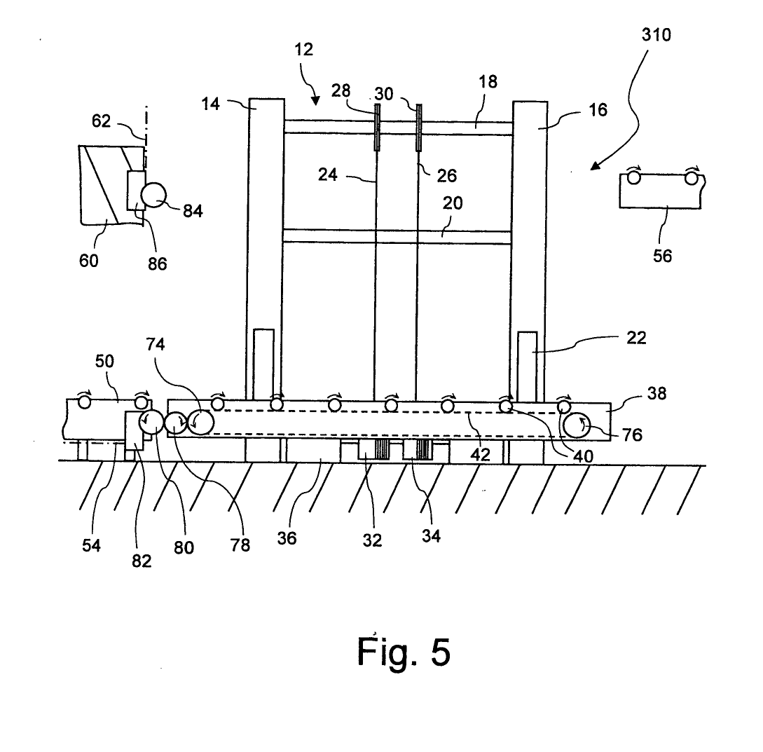

FIG. 5 is a front view of a third embodiment of a lifting station according to the invention, in which energy is transmitted mechanically via friction rollers, a lifting cradle being located in a lower lifting position;

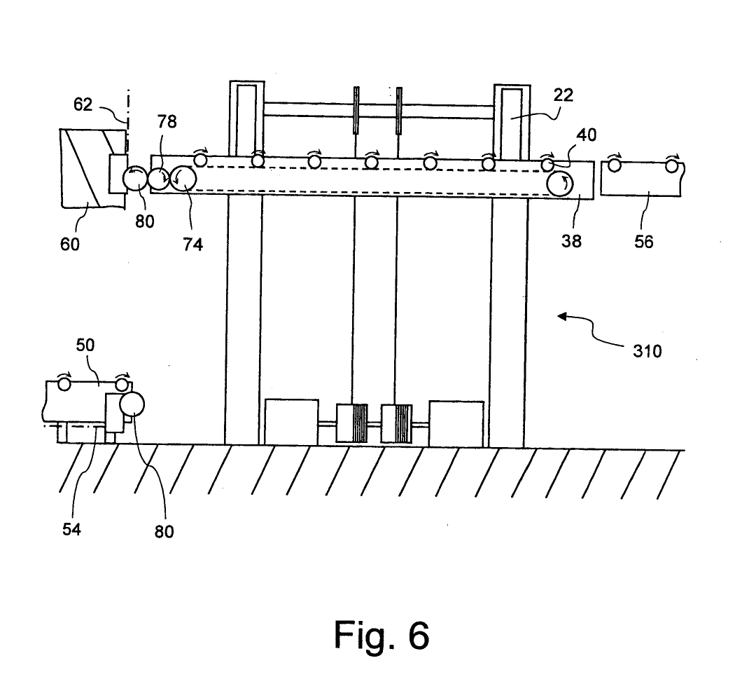

FIG. 6 shows the lifting station illustrated in FIG. 5, the lifting cradle being located in an upper lifting position.

FIG. 1 shows a first embodiment of a lifting station denoted as a whole by 10 in a front view. The lifting station 10 includes a support structure 12 composed of two vertical guide posts 14, 16 and crossbeams 18, 20 connecting same. The guide posts 14, 16 and the crossbeams 18, 20 may be made, for example, of steel profiles of rectangular or circular cross-section.

A lifting cradle 22 is supported on the support structure 12 via a plurality of guide rollers in a manner not illustrated in detail. The guide rollers bear against the guide posts 14, 16 on a plurality of sides and ensure that the lifting cradle 22 can move freely in the vertical direction while being fixed with respect to the support structure 12 perpendicularly to the vertical direction.

Acting upon the lifting cradle 22 are two steel cables 24, 26 which are guided over deflection rollers 28, 30 fixed to the upper crossbeam 18 to downwardly-located cable drums 32, 34 on which they are wound. The cable drums 32, 34 may be set in rotation by means of a drive motor 36, the lifting cradle 22 being lowered or raised depending on the direction of rotation of the cable drums 32, 34.

A roller conveyor 38 with which objects to be moved vertically can be conveyed in the longitudinal direction of the crossbeams 18, 20 is fixed to support arms of the lifting cradle 22 oriented in the direction of the viewer. For this purpose the roller conveyor 38 includes a multiplicity of rollers 40 which are connected via a chain 42, illustrated only partially and with broken lines for reasons of clarity, to an electric roller drive 44. Instead of a chain 42, a toothed belt or the like may, of course, be used. The roller drive 44 is connected via a conductor 46 having sliding contacts, which is fixed to an end face of the roller conveyor 38. The number of sliding contacts required depends on the selected voltage supply (e.g. direct current or three-phase current). In FIG. 1 only one sliding contact is shown for reasons of clarity and is denoted by 48.

A part of a lower conveyor system 50, also in the form of a roller conveyor, can also be seen in FIG. 1. A first counter-contact 52, which is connected via a feed line 54 to a voltage source (not shown in FIG. 1) controlled by an overall control system (also not shown), is fixed to the lower conveyor system 50.

Indicated at the top right in FIG. 1 is an upper conveyor system 56, also in the form of a roller conveyor. The upper conveyor system 56 may lead, for example, into a drying zone in which painted objects are dried.

A second counter-contact 58 is fixed to a rigid support arrangement 60, which may be, for example, a surrounding steel structure, on the opposite side of the roller conveyor 38 at the level of the upper conveyor system 56. The second counter-contact 58 is also connected to the controllable voltage supply via a further feed line 62.

The operation of the above-described lifting station 10 is explained below with reference to FIGS. 1 and 2.

It should be assumed that the vertically movable object is a painted motor vehicle body, which is designated 64 and indicated by broken lines in FIG. 1, and is fixed to a carrier referred to as the skid 66. The motor vehicle body 64 is to be moved vertically from the lower conveyor system 50 to the upper conveyor system 56 by means of the lifting station 10, in order to transfer the motor vehicle body 64 to a drying zone through which the upper conveyor system 56 extends.

The overall control system first ensures that the lifting cradle 22 is moved to its lower lifting position in which the roller conveyor 38 is at the same level as the lower conveyor system 50. As the lifting cradle 22 is lowered the sliding contact 48 comes into contact with the first counter-contact 52, which is fixed to the lower conveyor system 50. As soon as the contact is made the higher control system switches on the voltage supply. Current can now flow via the feed line 54 and the contacts 48, 52 to the roller drive 44. The latter actuates the rollers 40 via the chain 42. The motor vehicle body 64 can now be transferred to the roller conveyor 38 via the lower conveyor system 50. Control information of the kind known in the prior art in connection with trailing cables can now be transmitted via the closed circuit if required.

As soon as the skid 66 is conveyed only by the rollers 40 of the roller conveyor 38, the overall control system causes a continuous reduction of the electrical voltage that can be tapped at the counter-contact 52. In this way the rollers 40, and therefore the skid 66 guided thereon, are brought to a standstill. This state is shown in FIG. 1.

The overall control system now causes the drive motor 36 to raise the lifting cradle 22 with the motor vehicle body 64 arranged thereon until the upper lifting position is reached. As the upper lifting position is reached the sliding contact 48 comes into contact with the second counter-contact 58 which is fixed to the support arrangement 60. Once the lifting cradle 22 has reached its upper lifting position a continuously increasing voltage is applied to the feed line 62, whereby current flows via the contacts 48, 58 and the line 46. The roller drive 44 now sets the rollers 40 in motion, whereby the skid 66 with the body 64 fixed thereon is moved to the upper conveyor system 56. Its rollers finally take over the skid 66 and transfer the motor vehicle body 64 to the adjoining drying zone. The situation during the transfer of the motor vehicle body 64 to the upper conveyor system 56 is shown in FIG. 2.

FIGS. 3 and 4 show a further embodiment of a lifting station in representations corresponding to those of FIGS. 1 and 2. The same or corresponding parts are referred to by the same reference numerals.

In the lifting station shown in FIGS. 3 and 4 and designated as a whole by 210 the energy for driving the roller drive 44 is transferred not by electrical contacts but inductively to the lifting cradle 22. For this purpose a first induction coil 68, which can cooperate in the upper and lower lifting position with second induction coils 70 and 72 respectively, is fixed to the lifting cradle 22. By applying an alternating electrical field to the two second induction coils 70, 72 a current with which the electrical roller drive 44 can be fed can be induced by induction in the first induction coil 68. The induction takes place only when the first induction coil 68 is located immediately opposite one of the two second induction coils 70, 72.

The roller conveyor 38 of the lifting station 210 additionally includes a storage battery 73 which is connected between the first induction coil 68 and the roller drive 44. In the embodiment illustrated the storage battery 73, which is charged in the upper and lower lifting positions, can supply the roller drive 44 and additional control or measurement systems with electrical energy even when the lifting cradle 22 is in neither the upper nor the lower lifting position. The storage battery 73 may be so connected that it supplies only such additional systems on the lifting cradle 22 with electrical energy in a position-independent way, while the energy required for the roller drive 44 is always made available directly by the first induction coil 68.

The operation of the lifting station 210 shown in FIGS. 3 and 4 otherwise corresponds to that of the lifting station 10 as explained above with reference to FIGS. 1 and 2.

FIGS. 5 and 6 show a third embodiment of a lifting station in representations also corresponding to those of FIGS. 1 and 2. The same or corresponding parts are referred to here, too, by the same reference numerals as for the first embodiment shown in FIGS. 1 and 2.

The chain 42, shown completely here, which drives the rollers 40 of the roller conveyor 38, is guided over sprockets 74, 76 which, however, are not connected to a motor drive. Instead, the sprocket 74 that can be seen on the left in FIG. 5 is connected via a gear transmission to a friction wheel 78 which extends slightly beyond the rear end face of the roller conveyor 38.

Fixed in proximity to the lower conveyor system 50 is a friction drive wheel 80 that can be driven controllably by an electric motor 82 and cooperates with the friction wheel 78 when the lifting cradle is in the lower lifting position. A further friction drive wheel 86 that can be driven by an electric motor 88 is fixed to the support arrangement 60.

When the lifting cradle 22 is in one of the lifting positions illustrated in FIGS. 5 and 6, the friction wheel 78 of the roller conveyor 38 is in frictional engagement with one of the friction drive wheels 80 or 84. The associated motor 82 or 86 can then set the rollers 40 of the roller conveyor 38 in motion in a controlled manner via the corresponding friction drive wheel 80, 84, the friction wheel 78 and the sprockets 74, 76, in order to convey the object on the roller conveyor 38.

The function of the motors 82, 86 may also be taken over by the conveyor systems 50 and 56. In this case the friction drive wheels 80, 84 are coupled in a suitable manner only to the drive for the conveyor systems 50, 56. The rollers 40 of the roller conveyor 38 then move at the same speed in the corresponding lifting position as the rollers of the preceding or following conveyor system. It is also possible to provide a separate drive in one lifting position and to use the drive of the neighbouring conveyor system in the other lifting position. In this way only one friction wheel 78 on the roller conveyor 38 may in some cases be needed as a coupling.

1. Lifting station for vertically moving an object, in particular a vehicle body, in a surface treatment installation, comprising a fixed support structure and a vertically movable lifting cradle which is supported on the support structure and on which at least one conveying devices is arranged, characterised by
an energy transfer device with which energy can be transferred to the conveying device only in at least one selected lifting position of the lifting cradle.

2. Lifting station according to claim 1, characterised in that the at least one selected lifting positions include a lower and an upper dead centre position of the lifting cradle.

3. Lifting station according to claim 1, characterised in that the energy is electrical energy.

4. Lifting station according to claim 3, characterised in that the energy transfer device includes a fixed electrical contact and an electrical counter-contact which is arranged on the lifting cradle and cooperates with the fixed contact in the at least one selected lifting position.

5. Lifting station according to claim 3, characterised in that the energy transfer device makes possible inductive transfer of electrical energy.

6. Lifting station according to claim 5, characterised in that the energy transfer device includes a first, fixed induction loop and a second induction loop arranged on the lifting cradle.

7. Lifting station according to any one of the preceding claims, characterised by an energy accumulator arranged on the lifting cradle, with which energy accumulator energy transferred via the energy transfer device can be temporarily stored.

8. Lifting station according to claim 7, characterised in that the energy accumulator is a storage battery.

9. Lifting station according to claim 1, characterised in that the energy is mechanical energy.

10. Lifting station according to claim 9, characterised in that it includes a fixed drive unit and a coupling with which kinetic energy can be transmitted from the drive unit to the conveying device.

11. Lifting station according to claim 10, characterised in that the coupling is a friction clutch.

12. Lifting station according to claim 10, characterised in that the coupling is a magnetic clutch.

13. Lifting station according to claim 10, characterised in that the coupling is a toothed clutch.

14. Lifting station according to claim 1, characterised in that the conveying device is a roller conveyor or a chain conveyor.

15. Surface treatment installation having a lifting station according to claim 9, characterised in that the fixed drive unit is formed by a conveyor system located before or after the lifting station.

16. Lifting station according to claim 2, characterised in that the energy is electrical energy.

17. Lifting station according to claim 16, characterised in that the energy transfer device includes a fixed electrical contact and an electrical counter-contact which is arranged on the lifting cradle and cooperates with the fixed contact in the at least one selected lifting position.

18. Lifting station according to claim 16, characterised in that the energy transfer device makes possible inductive transfer of electrical energy.

19. Lifting station according to claim 18, characterised in that the energy transfer device includes a first, fixed induction loop and a second induction loop arranged on the lifting cradle.

20. Lifting station according to claim 2, characterised in that the energy is mechanical energy.
